(19) United States
(12) Patent Application Publication
(10) Pub. No.: US 2014/0075755 A1
(43) Pub. Date: Mar. 20, 2014

(54) SYSTEM AND METHOD FOR MANUFACTURING AN AIRFOIL

(71) Applicants: Zhaoli Hu, Greer, SC (US); Douglas Anthony Serieno, Simpsonville, SC (US); Peter Galen Stevens, Simpsonville, SC (US); Benjamin Erick Baker, Simpsonville, SC (US)

(72) Inventors: Zhaoli Hu, Greer, SC (US); Douglas Anthony Serieno, Simpsonville, SC (US); Peter Galen Stevens, Simpsonville, SC (US); Benjamin Erick Baker, Simpsonville, SC (US)

(73) Assignee: GENERAL ELECTRIC COMPANY, Schenectady, NY (US)

(21) Appl. No.: 13/617,235

(22) Filed: Sep. 14, 2012

(51) Int. Cl. B23P 15/02

(52) U.S. Cl. 29/889.721; 29/33 R

(57) ABSTRACT

A system for manufacturing an airfoil includes an outer surface of the airfoil, a cavity inside the airfoil, and a collimator outside of the airfoil. The system further includes a fluid column flowing from the collimator toward the outer surface of the airfoil, and a laser beam inside the fluid column creates a confined laser beam directed at the outer surface of the airfoil. A method for manufacturing an airfoil includes confining a laser beam inside a fluid column to create a confined laser beam, directing the confined laser beam at an outer surface of the airfoil, and creating a passage through the outer surface of the airfoil with the confined laser beam.

### FIELD OF THE INVENTION

The present invention generally involves a system and method for manufacturing an airfoil.

### BACKGROUND OF THE INVENTION

Turbines are widely used in industrial and commercial operations. A typical commercial steam or gas turbine used to generate electrical power includes alternating stages of stationary and rotating airfoils. For example, stationary vanes may be attached to a stationary component such as a casing that surrounds the turbine, and rotating blades may be attached to a rotor located along an axial centerline of the turbine. A compressed working fluid, such as but not limited to steam, combustion gases, or air, flows through the turbine, and the stationary vanes accelerate and direct the compressed working fluid onto the subsequent stage of rotating blades to impart motion to the rotating blades, thus turning the rotor and performing work.

The efficiency of the turbine generally increases with increased temperatures of the compressed working fluid. However, excessive temperatures within the turbine may reduce the longevity of the airfoils in the turbine and thus increase repairs, maintenance, and outages associated with the turbine. As a result, various designs and methods have been developed to provide cooling to the airfoils. For example, a cooling media may be supplied to a cavity inside the airfoil to convectively and/or conductively remove heat from the airfoil. In particular embodiments, the cooling media may flow out of the cavity through cooling passages in the airfoil to provide film cooling over the outer surface of the airfoil.

As temperatures and/or performance standards continue to increase, the materials used for the airfoil become increasingly thin, making reliable manufacture of the airfoil increasingly difficult. For example, the airfoil may be cast from a high alloy metal, and a thermal barrier coating may be applied to the outer surface of the airfoil to enhance thermal protection. A water jet or electron discharge machine (EDM) may be used to create cooling passages through the thermal barrier coating and outer surface, but the water jet or EDM may cause portions of the thermal barrier coating to chip off. Alternately, the thermal barrier coating may be applied to the outer surface of the airfoil after the cooling passages have been created by the water jet or EDM, but this requires additional processing to remove any thermal barrier coating covering the newly formed cooling passages.

A focused laser beam may also be used to create the cooling passages through the airfoil with a reduced risk of chipping the thermal barrier coating. The focused laser beam, however, requires precise positioning so that a focal point of the laser beam coincides with the outer surface of the airfoil, and the normal curvature and manufacturing tolerances associated with the outer surface of the airfoil makes precise positioning of the focal point with respect to the outer surface difficult to achieve. As a result, the focused laser beam may not completely penetrate through the outer surface, resulting in a damaged airfoil that must be refurbished or discarded. In addition, conventional focused laser beams have limited aspect ratios that can be achieved. Specifically, the ratio of the depth to the width for cooling passages created by conventional focused laser beams is typically less than three (i.e., the depth of the cooling passage must be at least three times the width of the cooling passage). Aspect rations of less than three may require excessively wide cooling passages through thicker portions of the airfoil. Therefore, an improved system and method for manufacturing an airfoil that does not require precise positioning of the airfoil and/or that enables larger aspect ratios for cooling passages would be useful.

### BRIEF DESCRIPTION OF THE INVENTION

Aspects and advantages of the invention are set forth below in the following description, or may be obvious from the description, or may be learned through practice of the invention.

One embodiment of the present invention is a system for manufacturing an airfoil. The system includes an outer surface of the airfoil, a cavity inside the airfoil, and a collimator outside of the airfoil. The system further includes a fluid column flowing from the collimator toward the outer surface of the airfoil, and a laser beam inside the fluid column creates a confined laser beam directed at the outer surface of the airfoil.

Another embodiment of the present invention is a method for manufacturing an airfoil that includes forming an outer surface of the airfoil, forming a cavity inside the airfoil, and confining a laser beam inside a fluid column to create a confined laser beam. The method further includes directing the confined laser beam at the outer surface of the airfoil and creating a passage through the outer surface of the airfoil with the confined laser beam.

In yet another embodiment of the present invention, a method for manufacturing an airfoil includes confining a laser beam inside a fluid column to create a confined laser beam, directing the confined laser beam at an outer surface of the airfoil, and creating a passage through the outer surface of the airfoil with the confined laser beam.

Those of ordinary skill in the art will better appreciate the features and aspects of such embodiments, and others, upon review of the specification.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 is a perspective view of an exemplary airfoil according to an embodiment of the present invention;

FIG. 2 is a plan view of a core that may be used to cast the airfoil shown in FIG. 1;

FIG. 3 is a perspective view of a system for manufacturing the airfoil shown in FIG. 1 according to one embodiment of the present invention; and

FIG. 4 is a flow diagram of a method for manufacturing the airfoil shown in FIG. 1 according to one embodiment of the present invention.

### DETAILED DESCRIPTION OF THE INVENTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention. As used herein, the terms “first,” “second,” and “third” may be used interchangeably to distinguish one component from another and are not intended to signify location or importance of the individual components. In addition, the terms “upstream” and “downstream” refer to the relative location of components in a fluid pathway. For example, component A is upstream from component B if a fluid flows from component A to component B. Conversely, component B is downstream from component A if component B receives a fluid flow from component A.

Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

Various embodiments of the present invention include a system and method for manufacturing an airfoil. The system generally includes a laser beam confined by a fluid column, and the confined laser beam may be used to create precise holes at particular angles through an outer surface of the airfoil. In particular embodiments, the system may further include a sensor operably connected with the airfoil and configured to generate a signal after the confined laser beam penetrates through the outer surface of the airfoil. A controller in communication with the sensor may receive the signal and execute logic stored in a memory that indicates a need to move the outer surface with respect to the laser beam and/or disables the laser beam when a predetermined condition exists. The predetermined condition may include, for example, a time for the laser beam to penetrate through the outer surface of the airfoil to a cavity inside the airfoil. Although exemplary embodiments of the present invention will be described generally in the context of an airfoil incorporated into a turbine, one of ordinary skill in the art will readily appreciate from the teachings herein that embodiments of the present invention are not limited to a turbine unless specifically recited in the claims.

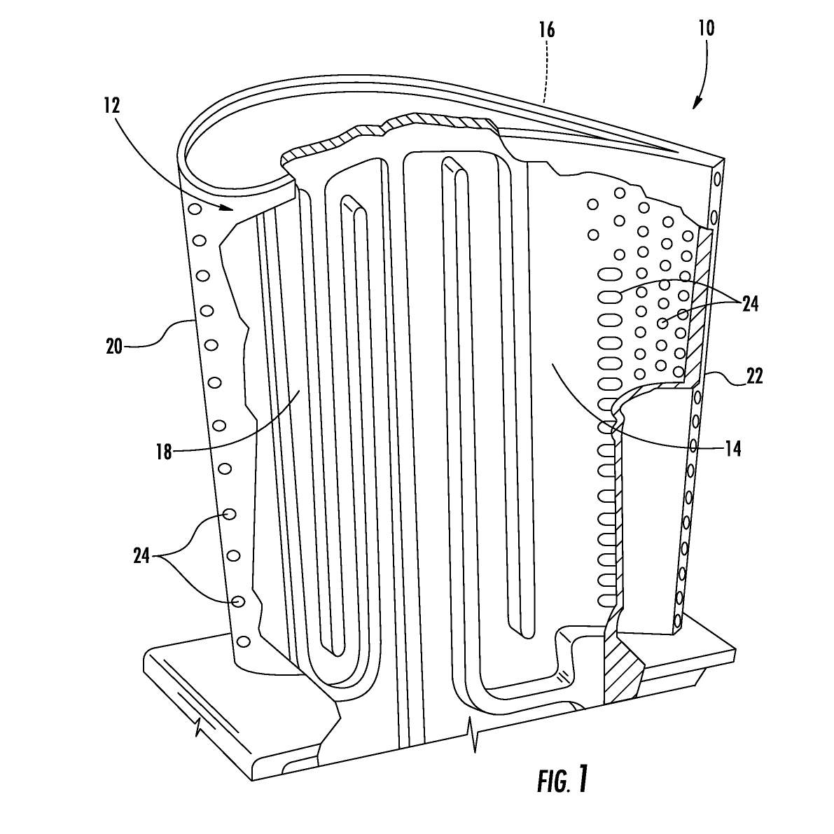

Referring now to the drawings, wherein identical numerals indicate the same elements throughout the figures, FIG. 1 provides a perspective view of an exemplary airfoil 10, such as may be incorporated into a turbine or other aeromechanical device. As shown in FIG. 1, the airfoil 10 generally includes an outer surface 12 having a pressure side 14 and a suction side 16. The pressure side 14 has a concave curvature, and the suction side 16 has a convex curvature opposed to the pressure side 14. The pressure and suction sides 14, 16 are separated from one another to define a cavity 18 inside the airfoil 10. The cavity 18 may provide a serpentine or tortuous path for a cooling media to flow inside the airfoil 10 to conductively and/or convectively remove heat from the airfoil 10. In addition, the pressure and suction sides 14, 16 further join to form a leading edge 20 at an upstream portion of the airfoil 10 and a trailing edge 22 downstream from the cavity 18 at a downstream portion of the airfoil 10. A plurality of cooling passages 24 in the pressure side 14, suction side 16, leading edge 20, and/or trailing edge 22 may provide fluid communication from the cavity 18 through the airfoil 10 to supply the cooling media over the outer surface 12 of the airfoil 10. As shown in FIG. 1, for example, the cooling passages 24 may be located at the leading and trailing edges 20, 22 and/or along either or both of the pressure and suction sides 14, 16. One of ordinary skill in the art will readily appreciate from the teachings herein that the number and/or location of the cooling passages 24 may vary according to particular embodiments, and the present invention is not limited to any particular number or location of cooling passages 24 unless specifically recited in the claims.

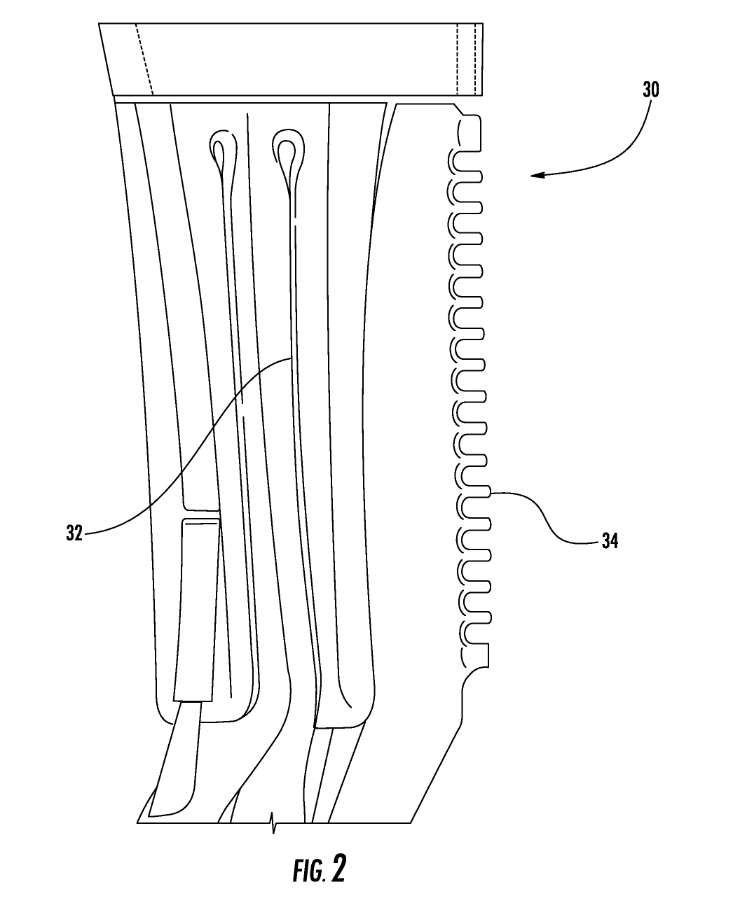

The exemplary airfoil 10 shown in FIG. 1 may be manufactured using any process known in the art. For example, the airfoil 10 may be manufactured by forging, machining, welding, extruding, and/or casting methods readily known in the art. FIG. 2 provides a plan view of a core 30 that may be used to manufacture the airfoil 10 shown in FIG. 1 by investment casting. As shown in FIG. 2, the core 30 may include a serpentine portion 32 with a number of long, thin branches or projections 34 that extend from the serpentine portion 32. The serpentine portion 32 generally corresponds to the size and location for the cavity 18 in the airfoil 10, and the projections 34 generally correspond to the size and location of the larger cooling passages 24 through the trailing edge 22 of the airfoil 10. The core 30 may be manufactured from any material having sufficient strength to withstand the high temperatures associated with the casting material (e.g., a high alloy metal) while maintaining tight positioning required for the core 30 during casting. For example, the core 30 may be cast from ceramic material, ceramic composite material, or other suitable materials. Once cast or otherwise manufactured, a laser, electron discharge machine, drill, water jet, or other suitable device may be used to refine or form the serpentine portion 32 and/or projections 34 shown in FIG. 2.

The core 30 may then be utilized in a lost wax process or other casting process as is known in the art. For example, the core 30 may be coated with a wax or other suitable material readily shaped to the desired thickness and curvature for the airfoil 10. The wax-covered core 30 may then be repeatedly dipped into a liquid ceramic solution to create a ceramic shell over the wax surface. The wax may then be heated to remove the wax from between the core 30 and the ceramic shell, creating a void between the core 30 and the ceramic shell that serves as a mold for the airfoil 10.

A molten high alloy metal may then be poured into the mold to form the airfoil 10. The high alloy metal may include, for example, nickel, cobalt, and/or iron super alloys such as GTD-111, GED-222, Rene 80, Rene 41, Rene 125, Rene 77, Rene N5, Rene N6, PWA 1484, PWA 1480, 4th generation single crystal super alloy, MX-4, Hastelloy X, cobalt-based HS-188, and similar alloys. After the high alloy metal cools and solidifies, the ceramic shell may be broken and removed, exposing the high alloy metal that has taken the shape of the void created by the removal of the wax. The core 30 may be removed from inside the airfoil 10 using methods known in the art. For example, the core 30 may be dissolved through a leaching process to remove the core 30, leaving the cavity 18 and cooling passages 24 in the airfoil 10.

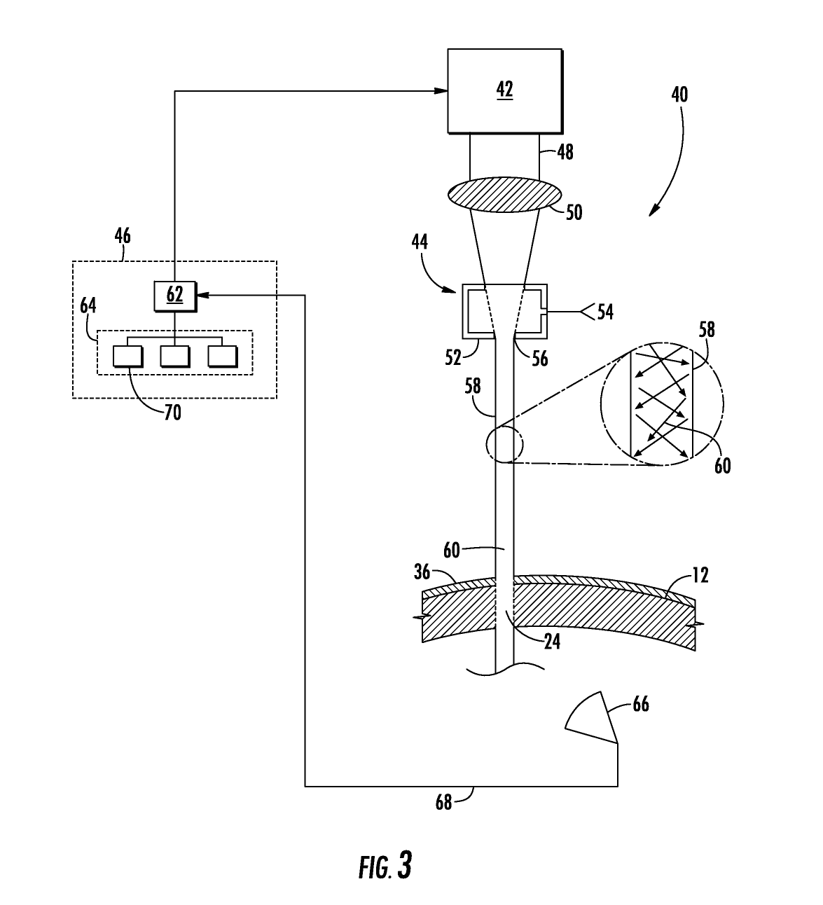

FIG. 3 provides a perspective view of a system 40 for creating additional cooling passages 24 through the airfoil 10. As shown in FIG. 3, a thermal barrier coating 36 may be applied over at least a portion of the outer surface 12 of the airfoil 10. The thermal barrier coating 36 may include low emissivity or high reflectance for heat, a smooth finish, and/or good adhesion to the underlying outer surface 12. For example, thermal barrier coatings known in the art include metal oxides, such as zirconia (ZrO₂), partially or fully stabilized by yttria (Y₂O₃), magnesia (MgO), or other noble metal oxides. The selected thermal barrier coating 36 may be deposited by conventional methods using air plasma spraying (APS), low pressure plasma spraying (LPPS), or a physical vapor deposition (PVD) technique, such as electron beam physical vapor deposition (EBPVD), which yields a strain-tolerant columnar grain structure. The selected thermal barrier coating 36 may also be applied using a combination of any of the preceding methods to form a tape which is subsequently transferred for application to the underlying substrate, as described, for example, in U.S. Pat. No. 6,165,600, assigned to the same assignee as the present invention.

The various embodiments of the system 40 may generally include a laser 42, a collimator 44, and a controller 46. The laser 42 may include any device capable of generating an unfocused laser beam 48. For example, the laser 42 may be an optically pumped Nd:YAG laser capable of producing the unfocused laser beam at a pulse frequency of approximately 10-50 kHz, a wavelength of approximately 500-550 nm, and an average power of approximately 10-100 W.

In the particular embodiment shown in FIG. 3, the laser 42 directs the unfocused laser beam 48 through a lens 50 to the collimator 44. As used herein, the collimator 44 includes any device that narrows and/or aligns a beam of particles or waves to cause the spatial cross section of the beam to become smaller. For example, as shown in FIG. 3, the collimator 44 may include a chamber 52 that receives the unfocused laser beam 48 along with a fluid 54, such as deionized or filtered water. An aperture or nozzle 56 having a diameter of approximately 20-150 microns directs the unfocused laser beam 48 inside a fluid column 58 toward the airfoil 10. The fluid column 58 may have a pressure of approximately 700-1,500 pounds per square inch, although the present invention is not limited to any particular pressure for the fluid column 58 unless specifically recited in the claims. As shown in the enlarged view in FIG. 3, the fluid column 58 is surrounded by air and acts as a light guide for the unfocused laser beam 48 to create a focused or confined laser beam 60 directed at the airfoil 10.

The confined laser beam 60 oblates the outer surface 12 of the airfoil 10, eventually creating the desired cooling passage 24 through the airfoil 10. The cylindrical geometry of the fluid column 58 and resulting confined laser beam 60 produce roughly parallel sides in the cooling passages 24. As a result, the aspect ratios for the cooling passages 24 created by the system 40 may be greater than previously achieved using conventional focused laser beams. For example, the system 40 shown in FIG. 3 may create cooling passages 24 through the outer surface 12 of the airfoil having aspect ratios as large as ten or more, depending on the particular composition of the airfoil 10.

The controller 46 may be any suitable processor-based computing device. For example, suitable controllers 46 may include personal computers, mobile phones (including smart phones), personal digital assistants, tablets, laptops, desktops, workstations, game consoles, servers, other computers and/or any other suitable computing devices. As shown in FIG. 3, the controller 46 may include one or more processors 62 and associated memory 64. The processor(s) 62 may generally be any suitable processing device(s) known in the art. Similarly, the memory 64 may generally be any suitable computer-readable medium or media, including, but not limited to, RAM, ROM, hard drives, flash drives, or other memory devices. As is generally understood, the memory 64 may be configured to store information accessible by the processor(s) 62, including instructions or logic that can be executed by the processor(s) 62. The instructions or logic may be any set of instructions that when executed by the processor(s) 62 cause the processor(s) 62 to provide the desired functionality. For instance, the instructions or logic can be software instructions rendered in a computer-readable form. When software is used, any suitable programming, scripting, or other type of language or combinations of languages may be used to implement the teachings contained herein. Alternatively, the instructions can be implemented by hard-wired logic or other circuitry, including, but not limited to application-specific circuits.

As shown in FIG. 3, a sensor 66 may be operably connected with the airfoil 10 and configured to generate a signal 68 after the confined laser beam 60 penetrates through the outer surface 12 of the airfoil 10. The sensor 66 may be a photo diode, a fluid sensor, or any other suitable sensor capable of detecting when the confined laser beam 60 has fully penetrated through the outer surface 12 of the airfoil 10. The controller 46 is in communication with the sensor 66 such that the controller 46 receives the signal 68. The controller 46 may execute logic 70 stored in the memory 64 to direct operation of the laser beam 42 based on the presence or absence or a predetermined condition. For example, the predetermined condition may be a predetermined time interval for the confined laser beam 60 to penetrate through the outer surface 12 of the airfoil 10. If the controller 46 does not receive the signal 68 indicating that the confined laser beam 60 has penetrated through the outer surface 12 of the airfoil 10 before the predetermined time interval is exceeded, this may indicate a problem or misalignment of the system 40 with respect to the outer surface 12. As a result, the logic 70 executed by the controller 46 may direct the controller 46 to disable the laser beam 42 until the system 40 can be inspected or examined. Alternately or in addition, the controller 46 may provide an indication to a user to move the outer surface 12 of the airfoil 10 with respect to the laser beam 42 to enhance operation of the system 40.

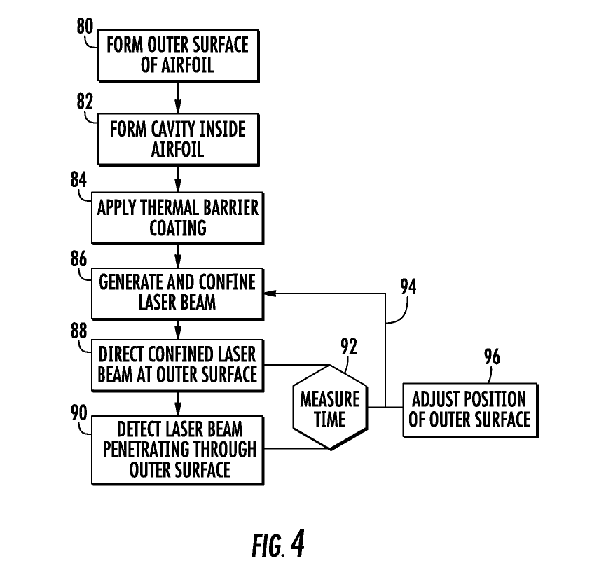

One of ordinary skill in the art will readily appreciate from the teachings herein that the system 40 described and illustrated with respect to FIG. 3 may provide a method for manufacturing the airfoil 10, and FIG. 4 provides a flow diagram of a method for manufacturing the airfoil 10 shown in FIG. 1 according to one embodiment of the present invention. At blocks 80 and 82, for example, the method may include forming the outer surface 12 of the airfoil 10 and forming the cavity 18 inside the airfoil 10, as previously described with respect to the airfoil 10 and core 30 shown in FIGS. 1 and 2. At block 84, the method may optionally include applying the thermal barrier coating 36 to the outer surface 12 of the airfoil 10, as shown in FIG. 3. Alternately, the method may proceed with generating the laser beam 48 and confining the laser beam 48 inside the fluid column 58 to create the confined laser beam 60, as shown in FIG. 3 and represented by block 86. At block 88, the method directs the confined laser beam 60 at the outer surface 12 of the airfoil 10 to create the cooling passage 24 through the outer surface 12 of the airfoil 10 with the confined laser beam 60. In particular embodiments, the method may create cooling passages 24 having an aspect ratio (i.e., the ratio of depth to width) of greater than three, and in some cases greater than ten.

The method may further include detecting when the confined laser beam 60 has fully penetrated the outer surface 12 of the airfoil 10, represented by block 90. The detection may include sensing at least one of light or fluid inside the cavity 18 of the airfoil 10. In addition, the method may measure the time interval between when the confined laser beam 60 was directed at the outer surface 12 and when the confined laser beam penetrated the outer surface 12, indicated by diamond 92. If the time interval exceeds the predetermined time interval, then the method may disable the laser beam 42, indicated by line 94. Alternately or in addition, the method may include moving the outer surface 12 of the airfoil 10 with respect to the laser beam 42 to enhance operations if the time interval exceeds the predetermined time interval, indicated by block 96.

The system 40 and methods described herein may provide one or more benefits or advantages over conventional focused lasers. For example, the fluid column 58 provides cooling to the outer surface 12 to reduce or avoid thermal damage that may occur with conventional focused lasers. In addition, the cylindrical shape of the fluid column 58 and confined laser beam 60 permit efficient ablation of the outer surface 12 at various distances from the laser beam 42. As a result, the time required for the system 40 to create the cooling passages 24 through the outer surface 12 of the airfoil 10 is no longer dependent on precise positioning of the outer surface 12 with respect to the laser beam 42. In addition, the cylindrical shape of the fluid column 58 and confined laser beam 60 produce parallel kerf walls, allowing for larger aspect ratios than previously available with convention focused lasers.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A system for manufacturing an airfoil, comprising:
a. an outer surface of the airfoil;
b. a cavity inside the airfoil;
c. a collimator outside of the airfoil;
d. a fluid column flowing from the collimator toward the outer surface of the airfoil; and
e. a laser beam inside the fluid column to create a confined laser beam directed at the outer surface of the airfoil.

2. The system as in claim 1, further comprising a sensor operably connected with the airfoil and configured to generate a signal after the confined laser beam penetrates through the outer surface of the airfoil.

3. The system as in claim 2, wherein the sensor comprises at least one of a photo diode or a fluid sensor.

4. The system as in claim 2, further comprising a controller in communication with the sensor such that the controller receives the signal, wherein the controller is configured to execute logic stored in a memory that disables the laser beam when a predetermined condition exists.

5. The system as in claim 4, wherein the predetermined condition comprises a time for the confined laser beam to penetrate through the outer surface of the airfoil.

6. A method for manufacturing an airfoil, comprising:
a. forming an outer surface of the airfoil;
b. forming a cavity inside the airfoil;
c. confining a laser beam inside a fluid column to create a confined laser beam;
d. directing the confined laser beam at the outer surface of the airfoil; and
e. creating a passage through the outer surface of the airfoil with the confined laser beam.

7. The method as in claim 6, wherein creating the passage through the outer surface of the airfoil comprises creating the passage having a depth at least three times as large as a width.

8. The method as in claim 6, further comprising applying a thermal barrier coating to the outer surface of the airfoil before directing the confined laser beam at the outer surface of the airfoil.

9. The method as in claim 6, further comprising detecting when the confined laser beam has fully penetrated the outer surface of the airfoil.

10. The method as in claim 9, wherein the detecting comprises sensing at least one of light or fluid inside the cavity.

11. The method as in claim 9, further comprising measuring a time interval between directing the confined laser beam at the outer surface of the airfoil and detecting when the confined laser beam has fully penetrated the outer surface of the airfoil.

12. The method as in claim 11, further comprising moving the outer surface of the airfoil with respect to the laser beam if the time interval exceeds a predetermined limit.

13. The method as in claim 11, further comprising disabling the laser beam if the time interval exceeds a predetermined limit.

14. A method for manufacturing an airfoil, comprising:
a. confining a laser beam inside a fluid column to create a confined laser beam;
b. directing the confined laser beam at an outer surface of the airfoil; and
c. creating a passage through the outer surface of the airfoil with the confined laser beam.

15. The method as in claim 14, wherein creating the passage through the outer surface of the airfoil comprises creating the passage having a depth at least three times as large as a width.

16. The method as in claim 14, further comprising applying a thermal barrier coating to the outer surface of the airfoil before directing the confined laser beam at the outer surface of the airfoil.

17. The method as in claim 14, further comprising detecting when the confined laser beam has fully penetrated the outer surface of the airfoil.

18. The method as in claim 17, further comprising measuring a time interval between directing the confined laser beam at the outer surface of the airfoil and detecting when the confined laser beam has fully penetrated the outer surface of the airfoil.

19. The method as in claim 18, further comprising moving the outer surface of the airfoil with respect to the laser beam if the time interval exceeds a predetermined limit.

20. The method as in claim 18, further comprising disabling the laser beam if the time interval exceeds a predetermined limit.
